(19) United States
(12) Patent Application Publication
(10) Pub. No.: US 2003/0220824 A1
(43) Pub. Date: Nov. 27, 2003

(54) Enterprise organization operational flow management system

(76) Inventor: Shou-Min Tseng, Taipei (TW)

Correspondence Address: BACON & THOMAS, PLLC, 625 SLATERS LANE, FOURTH FLOOR, ALEXANDRIA, VA, 22314

(21) Appl. No.: 10/150,994

(22) Filed: May 21, 2002

(51) Int. Cl. G06F 17/60

(52) U.S. Cl. 705/8

(57) ABSTRACT

An enterprise organization operation flow control system is provided. The enterprise organization operation flow control system automatically manages the operational flows of electronic applications in an enterprise organization and comprises:

an applicant management module to define a plurality of “applicants” who are allowed to access to said electronic applications;

an application form management module to define a plurality of “application forms” to be processed in said electronic application;

a role management module to define a plurality of “roles” to be connected to applicants defined in said applicant management module, according to the function and authorization of said applicants in respective electronic applications, so that common roles in a plurality of electronic applications and special roles in particular electronic applications are included, and to provide definitions of connections among respective applicants, their accessible electronic applications and their corresponding roles in said electronic applications;

a flow management module to define a plurality of operational steps required in said electronic applications and to define connections of respective electronic application forms to their respective corresponding operational steps in processing said electronic applications; and

a submission route management module to define submission routes of said electronic application in connection to said roles.

The submission route management module may further provide a group management submodule to define the connections between respective applicants and their corresponding groups comprising at least one applicant.

### FIELD OF INVENTION

The present invention relates to an enterprise organization operational flow management system especially to an enterprise organization operational flow management system that manages a variety of application-approval operational flows.

### BACKGROUND OF INVENTION

The enterprise organization operational flow management system has become a useful tool in the daily operations of an enterprise organization. With the enterprise organization operational flow management system, the computer system of an enterprise organization is able to integrate all the internal application and approval operations of the enterprise organization, such that all kinds of applications, requests, suggestions, decisions and other opinion expressions may be processed efficiently. All members and guests of the enterprise organization are able to use the computer system to conduct their daily operations.

In an enterprise organization operational flow management system, the transmission flow control of all kinds of applications and letters, reports is the most important task. Generally speaking, an enterprise organization operational flow management system is combined with or connected to an enterprise organization management system. In other words, in an enterprise organization management system all members (including members and guests) of an enterprise organization are divided into groups under a hierarchic structure, wherein one member belongs to at least one group. In all groups one or at least one member is defined as “leader”. In addition, members of a group are not necessarily a person. A group may also be a member of another group.

Under such a structure, there are two approaches to design the flow of the enterprise organization operation, i.e., the transmission route of application forms.

The first approach is to design the submission flows by standardization. For example, a standard application form is transmitted to the leader of a member, after the member fills up the application form, and is further transmitted to the leader of the leader. Special application forms are submitted to the leader of a member after the member fills up the application form, and is further transmitted to the leader of a member of a designated group.

With the standardization approach, the computer program to execute the operational flow may be simplified. However, due to the standardization, many or too many exceptions will be generated and special processing thereto is needed. For example, in an enterprise organization, one member does not have only one “leader”. In some cases, one particular member in an enterprise organization does not have only one “leader”, since one member may belong to several “groups” that don't have a hierarchic relation between them. In such a case, the “roles” of this member in respective “groups” may be different. For example, one member may be a leader to a group but is an ordinary member of another group. As a result, to determine who the “leader” to this member is in processing an application, will be difficult for a conventional enterprise organization management system. In addition, in an ad hoc group that is organized due to a particular need in the operation of the enterprise organization, an application may need to be transmitted through an exceptional route, or to be transmitted to more than one “leader” for approval.

Another approach is to treat all or most applications in specified routes. A look-up-table may be used to specify every application route. However, under such an approach, the computer program may be too large to be practicable. In addition, when the position (role and/or group) of a member is changed, all routes in the processing of applications relating to that member shall be reviewed one by one. Such a review ray cost a lot of burden in the human resource and mistakes due to omissions. Nevertheless, because every application route is specified, it is possible that an application is approved without examination due to misuse of authorization during the process in specifying the application routes.

It is thus necessary to provide a novel enterprise organization operation flow management system that is able to modulate all the internal application processes, such that all applications may be routed in an effective manner.

It is also necessary to provide an enterprise organization operation flow control system wherein applications are submitted through correct route(s) even when related members belong to a plurality of groups under the enterprise organization.

It is also necessary to provide an enterprise organization operation flow control system wherein applications are submitted through correct route(s) after the role and/or group of a member relative to said applications are changed.

### OBJECTIVES OF INVENTION

The objective of this invention is to provide a novel enterprise organization operation flow management system that is able to modulate all the internal application processes, such that all applications may be routed in an effective manner.

Another objective of this invention is to provide an enterprise organization operation flow control system whereby applications are submitted through correct route(s) even when related members belong to a plurality of groups under the enterprise organization.

Another objective of this invention is to provide an enterprise organization operation flow control system whereby applications are submitted through correct route(s) after the role and/or group of a member relative to said applications are changed.

Another objective of this invention is to provide a modulated enterprise organization operation flow control system.

### SUMMARY OF INVENTION

According to this invention, an enterprise organization operation flow control system is provided. The enterprise organization operation flow control system of this invention is used to automatically manage the operation flows of electronic applications in an enterprise organization and comprises:

an applicant management module to define a plurality of “applicants” who are allowed to access to said electronic applications;

an application form management module to define a plurality of “application forms” to be processed in said electronic application;

a role management module to define a plurality of “roles” to represent applicants who are required to participate in the operation of electronic applications to be used in an enterprise organization, according to the function and authorization of said applicants in respective electronic applications, so that common roles in a plurality of electronic applications and special roles in particular electronic applications are included, and to provide definitions of connections among respective applicants, their accessible electronic applications and their corresponding roles in said electronic applications;

a flow management module to define a plurality of operational steps required in said electronic applications and to define connections of respective electronic application forms to their respective corresponding operational steps in processing said electronic applications; and

a submission route management module to define submission routes of said electronic application to said roles.

The submission route management module may further provide a group management submodule to define the connections between respective applicants and their corresponding groups comprising at least one applicant.

### BRIEF DESCRIPTION OF INVENTION

These and other objectives and advantages may be clearly understood from the detailed description of this invention by referring to the following drawings.

In the drawing,

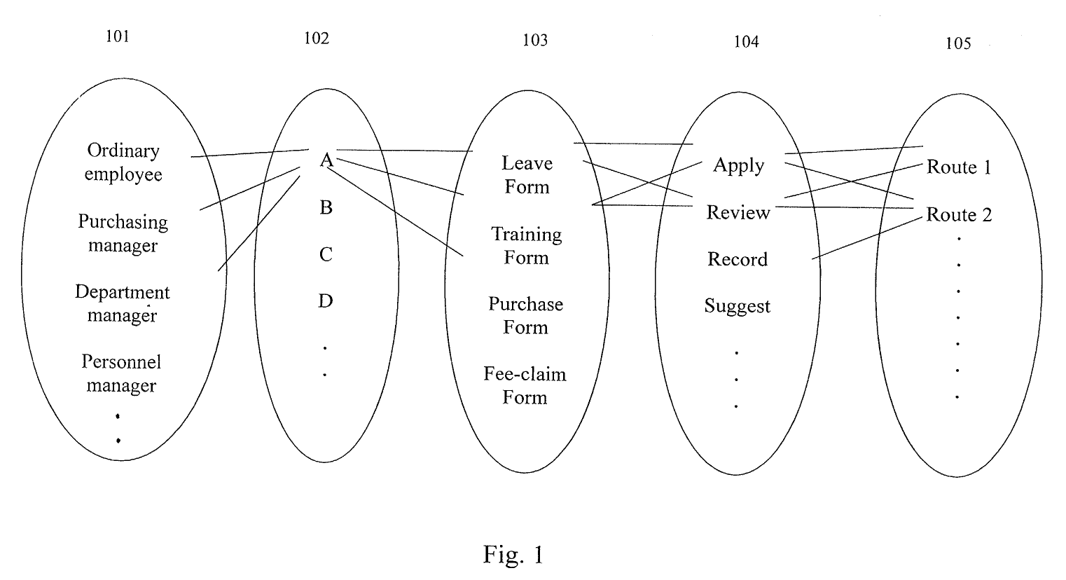

FIG. 1 illustrates the systematic diagram of the enterprise organization operation flow management system of this invention.

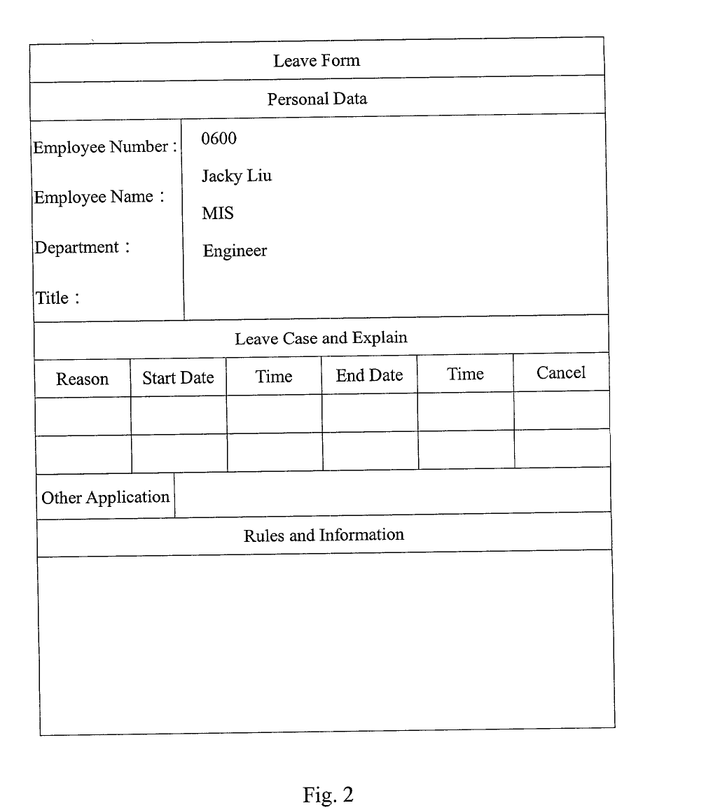

FIG. 2 shows a leave form applicable in the enterprise organization operation flow management system of this invention.

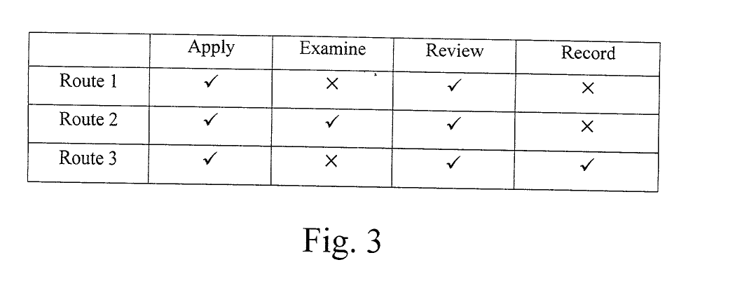

FIG. 3 shows a bypass table as used in the embodiment of the enterprise organization operation flow management system of this invention.

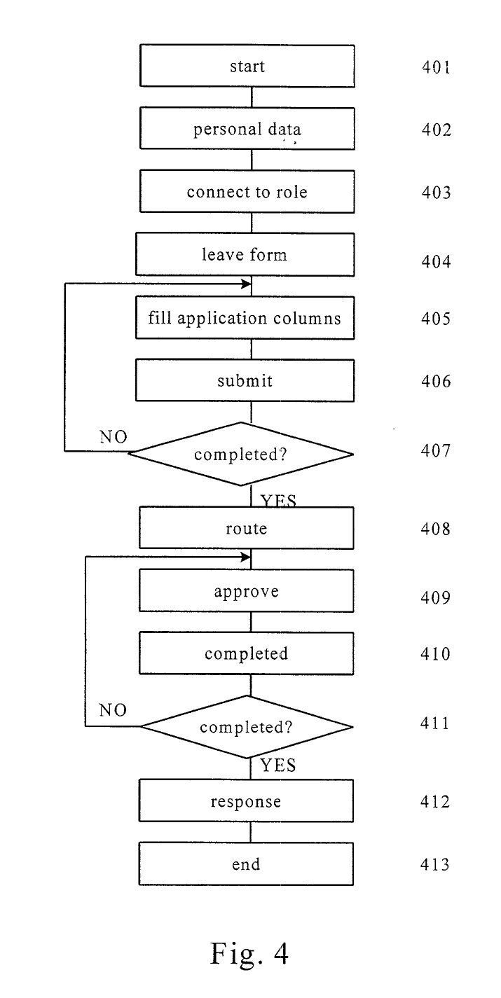

FIG. 4 shows the flow chart of the operation of an application of leave according to an embodiment of the enterprise organization operation flow management system of this invention.

### DETAILED DESCRIPTION OF INVENTION

The present invention discloses a modelized enterprise organization operation flow management system. In such a system, all kinds of internal and even external application operations of an enterprise organization ray be processed efficiently and correctly. The problems inherited in the conventional art may be solved without the need of complicated computer programs.

According to the enterprise organization operation flow management system of this invention, all application operations are processed by an enterprise organization operation flow management system comprising: a role management module 101, an applicant management module 102, an application form management module 103, a flow management module 104 and a transmission management module 105. FIG. 1 illustrates the systematic diagram of the enterprise organization operation flow management system of this invention. In this figure, all the modules and their relations are shown.

The role management module 101 defines all the “roles” of “applicants” (to be described in details hereinafter) in the application operations of an enterprise organization and contains these “roles” as its elements. As illustrates in FIG. 1, roles in the application operations of the enterprise organization of FIG. 1 include: ordinary employee, purchasing manager, department manager, president etc. In the embodiment of this invention, “roles” of “applicants” are preferably defined according to functions and authorization in the applicants' processing of the application operations. In other words, the “roles” defined and managed in the role management module 101 are not necessarily the “positions” or “job designations” of members of an enterprise but are roles of members of the enterprise in the processing of application operations. In practice, roles that may exist in all or most application operations are first defined and roles that may only exist in only some or even one application operation are also defined. For example, in the operation of a leave form, the form may be fist filled by an “ordinary employee”, approved by a “department manager” and submitted to “personnel manager” for reference. As a result, in a leave application, necessary “roles” include an ordinary employee, a department manager and a personnel manager. However, these three roles may also be required in an application of “annual performance”. Besides, the roles of “ordinary employee” and “department manager” are required in most application operations of an enterprise organization. These “roles” are all defined and controlled by the role management module 101. Other “roles” may be defined in the role management module 101 according to the character of the enterprise organization where the enterprise organization operation flow management system of this invention is used.

As a result, the “roles” as defined in the role management module 101 are roles that process the respective steps of the application operations in an enterprise organization. The “roles” defined in the role management module 101 will include roles that exist in common in a plurality of application operations and roles that exist in only one or a few application operations. The roles as defined in the role management module 101 may include: president, vice president, department manager, supervisor, personnel manager, purchasing manager, ordinary employee etc.

The applicant management module 102 defines and manages “applicants” who are allowed to operate in any step of the application operations of the enterprise organization. In general, an “applicant” is an officer, an employer or a member of an enterprise. However, a group may also be an “applicant”. In some embodiments of this invention, applicants who are allowed to operate in the application operations include external consultants, suppliers, customers, shareholders or even any third party. As a result, anyone who or any entity that is allowed to operate any function or any step in the application operations of the enterprise organization are defined as an “applicant” in the applicant management module 102.

In the applicant management module 102 provided is a look-up-table that defined the connections of an applicant with his/her name, title, password, operable applications (or connected application form, to be described in details hereinafter), his/her role(s) in that operable applications and other applicable information. The operation of defining, adding, deleting and changing the roles, operable applications etc., may be processed by system administrator through the operations as managed by the enterprise organization operation flow management system of this invention.

In order to facilitate such operations, the applicant management module 102 provides an administrator interface such that the administrator may define, add, delete and revise the elements as defined in the applicant management module 102.

The applicant form management module 103 defines all the application operations in the enterprise organization. In the enterprise organization operation flow management system of this invention, all the application operations of the enterprise organization are defined as “application forms”. In other words, all the application operations of the enterprise organization are divided into several steps, each step being defined by one or more columns in the application form, such that every application operation may be represented by an application form to be processed.

For example, the application of a leave may be defined by a leave form. A leave form will include the description or selections of date, time, reason and other content made by an applicant as an “ordinary employee”, the comments or approval of another applicant as his/her “department manager” and the comments and other instructions made by a third applicant as “personnel manager”. These steps such as applying, review, comment, approval etc. may also required in other application operations. As a result, it is possible to modelized the steps of most application operations with a generally purposed application form. Such a general application form may be used in most application operations with minor changes.

FIG. 2 shows a leave form applicable in the enterprise organization operation flow manager system of this invention. As shown in this figure, a leave form preferably contains predictive contents that may be selected by the applicants who participate in the operation of the leave form, i.e., ordinary employee, reviewer (department manager) and person in charge in the application. Such application forms are defined in the application form management module 103 to be accessed by applicants. When an application form is filled by a competent applicant, an application file will be generated automatically to be processed in a later step.

Among the role management module 101, the applicant management module 102 and the application form management module 103, a connection relation exists. Under such a connection relation, every “applicant” is connected to one or more “application forms”, representing application operations accessible to him/her, and every connected “application form” is connected to at least one “role” within the scope of that “application form”, representing the function and authority of the “applicant” in that “application form”. For example, an employer may be “purchase manager” of the enterprise organization as his/her position. This employer is connected to the role of “purchase manager” in the connection of him/her and the “application form” of “purchase form”. This employer may not be “ordinary employee” for all “purchase form”, since he/she is “purchasing manager”. At the same time, this employee is an “ordinary employee” in a leave form and is “department manager” to his subordinates. As such all “applicants” are connected to their respective “roles” in connection with the related “application forms”. A look-up-table (not shown) is thus provided in the role management module 101.

The flow management module 104 defines the operational flows of steps of all application operations in the enterprise organization. As a result, the flows of the application forms in their relative application operations are defined in the flow management module 104. For example, to a leave form, an applicant as “ordinary employee” may only fill into some particular columns (“descriptive columns”). In filling up the columns, only affective data are accepted in some of the columns. After the leave form is completed, the leave form is transmitted to the “department manager” of the employer for his/her approval. Here, the applicant in the role of “department manager” is required to express his/her opinions in the designated columns. To determine whether a step of an application operation is completed, exists in a particular application operation or is effective, is processed in the flow management module 104. As a result, in the flow management module 104, defined are steps of operations that are required to be operated by the “roles” that are required to participate in the application operations. Therefore, the flow management module 104 defines a plurality of operation steps or flows that need to be operated by roles such as “ordinary employee”, “purchasing manager”, personnel manager”, “department manager”, “president” etc.

In the embodiment as shown in FIG. 1, the operational steps as defined in the flow management module 104 are one-by-one corresponding to the roles as defined m the role management module 101. Of course, other ways of corresponding relations ray also be applicable to the enterprise organization operation flow management system of this invention.

Again, in the embodiment of this invention, the flow management module 104 defines all the operational steps or flows that are needed in the application operations. For example, the operational steps or flows may include “fill up descriptive columns”, “fill up suggestive columns”, “approval”, “submission”, “relay”, “response”, “record” etc. The flow management module 104 also defines the connections between respective operational steps and respective roles. Only “operational flows” that are connected to a “role” will be operated by “applicant” connected to that “role”. As a result, when an “applicant” connected to the “role” of “ordinary employee” enters into the operation, the applicant will be required to “fill up the descriptive columns” of and to “submit” the application form; When an “applicant” connected to the “role” of “department manager”, the applicant will be required to “approve” and to “relay” the application form.

The submission route management module 105 defines the submission routes of all the application forms as defined in the application form management module 103. For example, a leave form shall be first filled by an applicant in the role of “ordinary employee”, submitted to the applicant in the role of “department manager” connected to the first applicant, approved by the “department manager”, relayed to the applicant in the role of “personnel managers” to be recorded by the “personnel manager”, and responded to the first applicant. As a result, the definition given to the submission route of a leave form will be:

“ordinary employee”→“department manager”→“personnel manager”

→“ordinary employee”

As such, in the submission route management module 105, a plurality of inference rules defining the submission routes of the application forms are provided. The factors of these inference rules are connected to the “roles” as defined in the role management module 101, as are defined in the inference rules. A bypass table to reflect the submission connections between/among the submission routes and the roles may be used to define the submission routes. FIG. 3 shows a bypass table as used in the embodiment of the enterprise organization operation flow management system of this invention. As shown in the figure, the submission connections between or among the submission routes and the roles are easily defined

In order to make the submission route control more precisely, it is recommended that a group management submodule (not shown) be provided in the submission management module 105. The group management submodule defines the connections between respective applicants and their respective corresponding group or groups. Such definition does not ensure the correct submission routes of the application forms, but also makes it easy to correctly redefine the connection between one applicant and one group, when the connection thereof is changed. The “groups” as defined in the group management submodule shall comprise at least one applicant.

### Embodiment

In order to describe the embodiments of the enterprise organization operation flow management system of this invention, the operational flow of a leave form is taken as example. FIG. 4 shows the flow chart of the operation of an application of leave according to an embodiment of the enterprise organization operation flow management system of this invention. As shown in this figure:

First at 401, a request from a user to start an operation of leave application is received. At 402 the applicant management module 102 obtains the input data of the user and compares with the data as stored. Upon approval, at 403 the applicant management module 102 verifies the applicant's connection with the roles defined in the role management module 101 and finds the applicant is connected to the role of “ordinary employee”, in connection to the application form of “leave form”. A leave form operation is started at 404.

At 405 the flow management module 104 requests the applicant to fill up the “description columns” of the leave form as defined in the application form management module 103 and wait for the applicant's “submit” instruction at 406. Upon such an instruction, the flow management module 104 verifies whether the required columns are filled at 407. If the requirements are not fulfilled, the operation is returned to step 405; otherwise the submission route management module 105 allocates the next step to be submission to the department manager of the application at 408 and, thus, the application form is submitted to the corresponding applicant connected to that role at 409. At 410, the flow management module 104 waits for the department manager's instruction.

At 411, the department manager's instruction of completion of the application form is received and the flow management module 104 verifies whether the required columns of the application form is filled. Upon approval, at 412 the application form is transmitted to the applicant in the role of “personnel manager” and to the applicant who submitted the application, according to the connection as defined in the submission route management module 105; otherwise, the operation is returned to step 409, whereby the department manager is requested to complete the application form again.

After the leave form is transmitted to the personnel manager, another operation may be started by the personnel manager in the role of “ordinary employee” in that operation.

### Effects of Invention

As described above, in the enterprise organization operation flow management system of this invention, a role management module is provided, whereby the connection among an applicant, an application form and a role is well defined. The functions and authorizations of the applicant in particular application operation are thus defined.

In, the enterprise organization operation flow management system of this invention, all the operational steps or flows required in the application operations of an enterprise organization are defined as components and the connections between a role and a step or flow are also defined. Only when a step is connected to a role will the step be operated by an applicant connected to that particular role. As a result, all the operational steps or flows that may be operated by embers of the enterprise are defined as components. Security in the operations of the enterprise organization is thus ensured. The addition, deletion, revision to the authorization (operable flows) given to an applicant may be accomplished through the addition, deletion or revision of the connection between a role and a flow, using the enterprise organization operation flow management system of this invention. The problem of complicated operations and the problem of misuse of authorization in the conventional art may both be solved.

In addition, the submission route management nodule of the enterprise organization operation flow management system of this invention defines the connection between particular application forms and their corresponding submission routes. Addition, deletion and revision to the submission routes may also be accomplished easily.

When the connection among an applicant, an application form and a role is chanted, revisions to the definition of such connection may be easily accomplished using the enterprise organization operation flow management system of this invention. After the redefinition, the total connection will be changed. The complicated procedures in verifying the revisions are thus omitted.

As the enterprise organization operation flow management system of this invention has been shown and described with reference to preferred embodiments thereof, those skilled in the art will recognize that the above and other changes may be made therein without departing from the spirit and scope of the invention.

What is claimed is:

1. An enterprise organization operation flow management system to automatically manage the operation flows of electronic applications in an enterprise organization, comprising:
an applicant management module to define a plurality of “applicants” who are allowed to access to said electronic applications;
an application form management module to define a plurality of “application forms” to be processed in said electronic application;
a role management module to define a plurality of “roles” to be connected to said applicants defined in said applicant management module, according to the function and authorization of said applicants in the operations of respective electronic applications, and to define connections among respective applicants, their accessible electronic applications and their corresponding roles in said electronic applications;
a flow management module to define a plurality of operational steps required in said electronic applications and to define connections of respective electronic application forms to their corresponding operational steps in the operations of said electronic applications; and
a submission route management module to define submission routes of said application forms in connection to said roles.

2. The enterprise organization operation flow management system according to claim 1 wherein said submission route management module further comprises a group management submodule to define the connections between respective applicants and their corresponding groups comprising at least one applicant.

3. The enterprise organization operation flow management system according to claim 1 wherein roles as defined in said role management module comprise common roles in a plurality of electronic applications and special roles in particular electronic applications.

4. The enterprise organization operation flow management system according to claim 1, further comprising a user interface to provide functions including adding, revising and/or deleting components of respective modules.

5. The enterprise organization operation flow management system according to claim 1, wherein said flow management module allows an “applicant” to operate “operational steps” connected to said “roles”, when said “applicant” is defined to be connected to said “application form” and said “role”.

6. The enterprise organization operation flow management system according to claim 2, wherein said submission route management module allows an “application form” to be submitted to another “applicant” connected to a “group” to which one former “applicant” that operates said “application form” is connected.
